(19) United States
(12) Patent Application Publication
(10) Pub. No.: US 2017/0212438 A1
(43) Pub. Date: Jul. 27, 2017

(54) TONER FORMULATIONS HAVING IMPROVED TONER USAGE EFFICIENCY

(71) Applicant: LEXMARK INTERNATIONAL, INC., LEXINGTON, KY (US)

(72) Inventors: KATSURI RANGAN SRINIVASAN, LONGMONT, CO (US); CHRISTOPHER MICHAEL BENNETT, PARIS, KY (US); MATTHEW DAVID HEID, SIMPSONVILLE, KY (US); ANN P. HOLLOWAY, LEXINGTON, KY (US); VLADIMIR KANTOROVICH, BOULDER, CO (US); JODI LYNN WALSH, BERTHOUD, CO (US); PETER NIKOLAVICH YARON, DENVER, CO (US)

(21) Appl. No.: 15/412,563

(22) Filed: Jan. 23, 2017

Related U.S. Application Data
(60) Provisional application No. 62/281,637, filed on Jan. 21, 2016.

(51) Int. Cl. G03G 9/08; G03G 9/09; G03G 9/087

(52) U.S. Cl. CPC G03G 9/0823; G03G 9/0819; G03G 9/0827; G03G 9/0825; G03G 9/08755; G03G 9/0926; G03G 9/0904

(57) ABSTRACT

A toner composition and a method of making a toner composition wherein toner particles having an average size range of 1-25 μm may be mixed with an extra particulate additives including large silica particles having a primary particle size in the range of 60 nm to 120 nm, medium fumed silica particles having a primary particle size in the range of 30 nm to 60 nm, antimony oxide doped tin oxide (Sb₂O₅ doped SnO₂) coated titania conductive additive and acicular titania oxide. Optionally small silica having a primary particle size in the range of 2 nm to 20 nm may be mixed with the medium silica, large silica, titania conductive additive and the acicular titania oxide. This use of this particular set of titania and silica extra particulate additives in the toner generates less waste toner, increasing toner usage efficiency and significantly reduces toner consumption without impacting image quality and charge characteristics.

### CROSS REFERENCES TO RELATED APPLICATIONS

This patent application is the utility application of U.S. Provisional Patent Application Ser. No. 62/281,637, filed Jan. 21, 2016 entitled “Toner Formulations Having Improved Toner Usage Efficiency”.

### BACKGROUND

The present invention relates generally to an improved toner composition and method to make the same by using specific types of silica and titania as extra particulate additives (‘EPAs’) wherein the toner formulation generates less toner waste, increases toner usage efficiency and significantly reduces toner consumption without impacting image quality and charge characteristics. Also, the ratio of silicas to titanias is about 3.5 to about 1 and all increments there between, and the ratio of an electro-conductive titania with a primary particle size of about 40 nm to an acicular titania is about 1 to about 0.15, and all increments there between.

### DESCRIPTION

Toner may be utilized in image forming devices, such as printers, copiers and/or fax machines to form images upon a sheet of media. The image forming apparatus may transfer the toner from a reservoir to the media via a developer system utilizing differential charges generated between the toner particles and the various components in the developer system. Control of flow properties may be achieved by dry toner surface modification and the attachment or placement of fine particles, or extra-particulate additives on the surface of the particles. Moreover, decrease in overall toner usage by the consumer is an important concern to the consumer in terms of a cost and environmental standpoint.

### SUMMARY OF THE INVENTION

An aspect of the present disclosure relates to a toner composition which may be used in an electrophotographic printer or printer cartridge. This toner formulation generates less toner waste, increases toner usage efficiency and significantly reduces toner consumption without impacting image quality and charge characteristics. This improvement is accomplished by finishing the fused toner particle with a unique set of EPAs. The toner composition comprises toner particles having an average size in the range of 1-25 μm that may be mixed with a specific mixture of silicas and titanias—namely a first fumed silica having a primary particle size in the range of 30 nm-60 nm, a second silica having a primary particle size in the range of 60 nm-120 nm, an electro-conductive titania having a primary particle size of about 40 nm and an acicular titania having a size of about 1.6 to 1.7 μm in length and about 130 nm in diameter. This unique set of EPAs leads to reduction in toner consumption relates to a decrease in toner-to-cleaner or waste toner as well as drastic improvement in toner starvation, environmentally desirable need for less cartridge manufacturing, less toner waste, reductions in paper consumption as well as significant savings in terms of cost of printing per page. Moreover toner consumption is reduced without affecting the overall print quality. The ratio of the silicas to the titanias is about 3.5 to 1, and increments there between. Ratio of the non-acicular electro-conductive to the acicular titania is about 1 to 0.15, and increments there between. The ratio of the smaller fumed silica having a primary particle size of about 30 nm-60 nm to the larger silica having a primary particle size of 60 nm-120 nm is about 3 to 1, and no smaller than 1 to 1.

### DETAILED DESCRIPTION

It is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items

### BACKGROUND

Electrophotographic printers and cartridges typically use either a mechanically milled toner or a chemically prepared toner (‘CPT’). Chemically prepared toner can be a toner derived from using a suspension polymerization method, an emulsion agglomeration (‘EA’) method, or an aggregation method. Independent of the method of preparation, toner flow properties and print quality metrics can be suitably manipulated by use of EPAs to the toner particle surface. EPAs help improve the toner flow behavior, lower or eliminate the tendency to brick or cake under high temperature and/or humidity, improve transfer of toner from a photoreceptor to paper or an image transfer member, transfer between an image transfer member and paper, or regulate the toner charge across various environments (ie, varying temperature and humidity) and improve print quality.

Whereas most of the toner is printed on a document, a small amount of toner is lost as waste. Hence there is a desire to minimize waste toner and therefore maximize the toner usage efficiency. Toner usage efficiency is described as the ratio of toner on a printed page to total toner used. Similarly, waste toner will be herein after referred to as “toner in the cleaner” or “toner-to-cleaner (TTC)”.

Several EPAs have been employed in the surface treatment of toner. These EPAs include various inorganic oxides such as silicon dioxide also known as silica, titanium dioxide also known as titania, aluminum oxide (also known as alumina), and composite mixtures of titania, silica and/or alumina. Further metal soaps have also been used to improve the transfer efficiency of a toner.

Inorganic oxides may be obtained using a fuming process or a colloidal process. Fumed silica, also known as pyrogenic silica, is produced in a flame. This type of silica consists of microscopic droplets of amorphous silica fused into branched, chainlike, three-dimensional secondary particles which then agglomerate into tertiary particles. In a typical case, fumed silica is produced by pyrolysis of silicon tetrachloride.

Inorganic oxides such as silica, titania, alumina etc., can vary in their primary particle size from about a 5 nm to several micrometers. Moreover to achieve uniform print quality across different type of environments, inorganic oxides are surface treated with various treatments such as organosilanes and silicone oil. The extent of surface treatment of the hydroxyl groups in an inorganic oxide can also be varied. In regards to the primary particle size of then silica, the toner flow can be significantly improved by use of smaller primary particle size silica, usually about 5 nm-15 nm in combination with a large primary particle size such as 40 nm-250 nm. This larger sized silica serves as a useful ‘spacer’. Spacers are effective in keeping individual toners apart and hence can improve the storage stability. Silicas with a primary particle size of about 100 nm have been used in CPT toners to be effective spacers. The large silica described as a spacer is typically prepared by a sol-gel or colloidal process. Whereas the medium size silica, about 30 nm-60 nm primary particle size help with toner flow, they are ineffective spacers, and the large silica while functioning as a spacer requires to be used at higher concentrations or levels to help with toner flow. Hence there is a need for a silica that can help both with toner flow and also act as a suitable spacer between surface treated toner particles.

Metal oxides such as alumina, silica, titania, zirconia, ceria, strontium titanate, etc. have been used as surface additives for toner. Many of these additives may be insulative, having a volume resistivity in the range of E⁷ to E⁶ ohm-cm. A conductive additive may be defined as semi-conductive materials, having a volume resistivity in the range of E⁻¹ (10⁻¹) to about E⁶ (10⁶) ohm-cm or conductive material having a volume resistivity in the range of E⁻¹ to E⁶, including all values and increments therein. The conductive additives may be present in the form of particles wherein a conductive or semi-conductive material itself forms the particle. The conductive particle may therefore include antimony doped tin oxide, antimony doped indium oxide, antimony doped indium-tin oxide, zinc oxide with or without metal doping, carbon black and selected metal oxides, etc. In addition, the conductive additives may include an insulative particle that may be coated or otherwise doped with a semiconductive or conductive material. For example, the conductive particle may utilize a relatively nonconductive or semiconductive silica, alumina, titania, zinc oxide, etc., which may then be coated with inorganic or organic substances. Such coating substance may include poor metal oxides such as antimony oxide, tin oxide, etc. As defined herein, poor metals may include, for example, gallium, indium, thallium, germanium, tin, lead, antimony, bismuth, polonium or combinations thereof. The conductive coating may therefore include antimony doped tin oxide, antimony doped indium oxide, antimony doped indium-tin oxide, etc. Further conductive coatings may include organic conducting polymers such as polyanilines, polypyrroles, polythiophenes, etc. The above referenced conductive additives may have a particle size in the range of about 5 nm to about 2000 nm, including all values and increments therein. In addition, the conductive particles may have various geometries and may be, for example, substantially spherical, acicular, flake or a combination of geometries. By substantially spherical, it may be understood to have a degree of circularity of greater than or equal to about 0.90. Particular exemplary conductive additives may include antimony oxide doped tin oxide (Sb₂O₅ doped SnO₂) coated titania, having a particle size in the range of 10 nm to 400 nm, including all values and increments therein. In addition, the additives may have a specific surface area in the range of 1-60 m²/g as measured by BET method. The coated titania may also be treated with a coupling agent. Such additives may be available from Ishihara Corporation USA (ISK) under the product numbers ET-300W (sized 40 nm), ET-600W, ET-500W; as well as from Titan KKK under the product name EC-300T.

The inventors have surprisingly discovered that the use of 70 nm-120 nm silica in combination with a spherical electro-conductive titania and an acicular titania helps impart the needed optimum spacer behavior and significantly improves the toner usage efficiency. The conductive titanium dioxide used thus can help in the overall toner usage efficiency and can also be used as a spacer or as a replacement for a silica that is similar in size to the conductive titanium dioxide. The improved toner usage efficiency is a result of lower waste toner. Having this optimum spacing behavior generates a toner formulation having less toner waste, increases toner usage efficiency and significantly reduces toner consumption without impacting image quality and charge characteristics. The conductive titania along with the acicular titania and small and medium silica can be used with either a large silica derived from a sol-gel or fuming process. The spherical electro-conductive titania is preferably about 40 nm, and the acicular titania has an aspect ratio of about 1.68 μm×130 nm.

The present disclosure is directed at a toner formulation which generates less toner waste, increases toner usage efficiency and significantly reduces toner consumption without impacting image quality and charge characteristics by providing extra particular agents to the toner particle surface including a specific mixture of silicas and titanias—namely a first fumed silica having a primary particle size of about 30 nm-50 nm, a second silica having a primary particle size of 70 nm-110 nm, an electro-conductive titania having a primary particle size of about 40 nm and an acicular titania that is preferably about 1.68 μm in length and about 130 nm in diameter. The larger silica particle is preferably prepared by a fumed process and the surface treatment of the fumed silica contains about 1% by weight of silica of silicone oil to about 5 wt % of silicone oil, and most preferably less than about 4 wt % of the silicone oil on the said colloidal silica. The toner particles may be prepared by a chemical process, such as suspension polymerization or emulsion aggregation. In one example, the toner particles may be prepared via an emulsion aggregation procedure, which generally provides resin, colorant and other additives. More specifically, the toner particles may be prepared via the steps of initially preparing a polymer latex from a set of polyester resins that are in a polymer resin emulsion form. The polymer latex so formed may be prepared at a desired molecular weight distribution (MWD=Mw/Mn) and may, for example, contain both relatively low and relatively high molecular weight fractions to thereby provide a relatively bimodal distribution of molecular weights. Pigments may then be milled in water along with a surfactant that has the same ionic charge as that employed for the polymer latex. Release agent (e.g., a wax or mixture of waxes) including olefin type waxes such as polyethylene may also be prepared in the presence of a surfactant that assumes the same ionic charge as the surfactant employed in the polymer latex. Optionally, one may include a charge control agent.

The polymer resin emulsion, pigment dispersion and wax dispersion may then be mixed and the pH adjusted to cause flocculation. For example, in the case of anionic surfactants, acid may be added to adjust pH to neutrality. Flocculation therefore may result in the formation of a gel where an aggregated mixture may be formed with particles of about 1-2 μm in size.

Such mixture may then be heated to cause a drop in viscosity and the gel may collapse and relative loose (larger) aggregates, from about 1-25 μm, may be formed, including all values and ranges therein. For example, the aggregates may have a particle size between 3 μm to about 15 μm, or between about 4 μm to about 10 μm. In addition, the process may be configured such that at least about 80-99% of the particles fall within such size ranges, including all values and increments therein. Base may then be added to increase the pH and reionize the surfactant or one may add additional anionic surfactants. The temperature may then be raised to bring about coalescence of the particles. Coalescence is referenced to fusion of all components. The toner may then be removed from the solution, washed and dried.

It is also contemplated herein that the toner particles may be prepared by a number of other methods including mechanical methods, where a binder resin is provided, melted and combined with a wax, colorant and other optional additives. The product may then be solidified, ground and screened to provide toner particles of a given size or size range.

The resulting toner may have an average particle size in the range of 1 μm to 25 μm. The toner may then be treated with a blend of extra particulate agents, including hydrophobic fumed alumina, hydrophobic fumed small silica sized less than 20 nm, medium silica sized 40 nm to 50 nm, large fumed silica sized 70 nm to 80 nm, and titania. Treatment using the extra particulate agents may occur in one or more steps, wherein the given agents may be added in one or more steps.

The alumina (Al₂O₃) that may be used herein may have an average primary particle size in the range of 5 nm to 100 nm, including between 7 nm to 50 nm (largest cross-sectional linear dimension) or between 7 nm to 25 nm. In addition, the alumina may be surface treated with an inorganic/organic compound which may then improve mixing (e.g., compatibility) with organic based toner compositions. For example, the alumina may include a silane coating or other coatings, such as chloro(dimethyl)octylsilane, dimethoxy(methyl)octylsilane, or methoxy(dimethyl)octylsilane. The alumina may be present in the range of 0.01% to 1.0% by weight of the toner composition, including in the range of 0.10% to 0.50% by weight. An example of the aluminum oxide may be that available from Evonik Corporation under the tradename AEROXIDE and product number C 805.

Referring again to the extra-particulate agents that may be used herein, small silica may be understood as silica (SiO₂) having an average primary particle size in the range of 2 nm to 20 nm, or between 5 nm to 15 nm (largest cross-sectional linear dimension) prior to any after treatment, including all values and increments therein. The small silica may be present in the toner formulation as an extra particulate agent in the range of 0.01% to 3.0% by weight of the toner composition, such as 0.1% to 1.0% by weight, including all values and increments therein. In addition, this small silica may be treated with hexamethyldisilazane. An exemplary silica may be available from Evonik Corporation under the tradename AEROSIL and product numbers R812.

Medium sized fumed silica may be understood as silica having a primary particle size in the range of 30 nm to 60 nm, or between 40 nm to 50 nm, prior to any after treatment, including all values and increments therein. Primary particle size may be understood as the largest linear dimension through a particle volume. The medium sized silica may be present in the toner formulation as an extra particulate agent in the range of 0.1% to 2.0% by weight of the toner composition, including all values and increments in the range of 0.1% to 2.0% by weight. The medium sized silicas may also be treated with surface additives that may impart different hydrophobic characteristics or different charges to the silica. For example, the silica may be treated with hexamethyldisilazane (silane), polydimethylsiloxane (silicone oil), etc. Exemplary silicas may be available from Evonik Corporation under the tradename AEROSIL and product numbers RX-50 or RY-50. Medium silica such as TG-5185 available from Cabot Corporation may also be used.

Large silica may be understood as silica having a primary particle size in the range of 60 nm to 120 nm, or preferably between 70 nm to 110 nm, prior to any after treatment, including all values and increments therein. The large silica may be present in the toner formulation as an extra particulate agent in the range of 0.1 wt % to 2 wt %, for example in the range of 0.25 wt % to 1.5 wt % of the toner composition. The large silica may also be treated with surface additives that may impart different hydrophobic characteristics or different charges to the silica. For example, the large silica may be treated with hexamethyldisilazane, polydimethylsiloxane, dimethyldichlorosilane, and combinations thereof, wherein the treatment may be present in the range of 1 wt % to 10 wt % of the silica. The weight % of a polydimethylsiloxane on the silica is about 0.5 wt % to about 5wt %, and more preferably from about 0.5 wt % to about 4wt %. Exemplary large fumed silicas may be available from Evonik Corporation under the trade name VPRY4OS or VPRX40S. Exemplary large colloidal silica may be available from Evonik Corporation under the trade name of VPSY110, or from Sukgyung AT, Inc. under the trade name SGSO100C.

In addition, titania (titanium-oxygen compounds such as titanium dioxide) may be added to the toner composition as an extra particulate additive. The titania may be a combination of an electro-conductive antimony oxide doped tin oxide Sb₂O₅ doped SnO₂) coated titania with a primary particle size of about 40 nm, and an acicular titania mean particle length in the range of 0.1 μm to 3.0 μm, and a mean particle diameter in the range of 0.01 μm to 0.2 μm. The titania may be present in the formulation in the range of about 0.01% to 2.0% by weight of the toner formulation, and preferably such as 0.1% to 1.5%. The acicular titania may include a surface treatment, such as aluminum oxide. An example of acicular titania contemplated herein is sized 1.68 μm in length and about 130 nm in diameter include FTL-110 available from ISK USA. An example of an electro-conductive antimony oxide doped tin oxide (Sb₂O₅ doped SnO₂) coated titania with a primary particle size of about 40 nm contemplated herein may include ET-300W available from ISK USA. Other contemplated titanias may include those available from DuPont; Kemira of Finland under the product designation Kemira RODI or RDI-S; or Huntsman Pigments of Texas under the product name TIOXIDE R-XL.

The disclosed method to make the toner of the present invention operates to provide a finishing to toner particles, as more specifically described below. Such finishing may rely upon what may be described as a device for mixing, cooling and/or heating the particles which is available from Hosokawa Micron BV and is sold under the trade name “CYCLOMIX.” Such device may be understood as a conical device having a cover part and a vertical axis which device narrows in a downward direction. The device may include a rotor attached to a mixing paddle that may also be conical in shape and may include a series of spaced, increasingly wider blades extending to the inside surface of the cone that may serve to agitate the contents as they are rotated. Shear may be generated at the region between the edge of the blades and the device wall. Centrifugal forces may therefore urge product towards the device wall and the shape of the device may then urge an upward movement of product. The cover part may then urge the products toward the center and then downward, thereby providing a feature of recirculation.

The device as a mechanically sealed device may operate without an active air stream, and may therefore define a closed system. Such closed system may therefore provide relatively vigorous mixing and the device may also be configured with a heating/cooling jacket, which allows for the contents to be heated in a controlled manner, and in particular, temperature control at that location between the edge of the blades and the device wall. The device may also include an internal temperature probe so that the actual temperature of the contents can be monitored.

For example, conventional toner or chemically prepared toner (CPT) may be combined with one or more extra particulate additives and placed in the above referenced conical mixing vessel. The temperature of the vessel may then be controlled such that the toner polymer resins are not exposed to a corresponding glass transition temperature or Tg which could lead to some undesirable adhesion between the polymer resins prior to mixing and/or coating with the EPA material. Accordingly, the heating/cooling jacket may be set to a temperature of less than or equal to the Tg of the polymer resins in the toner, and preferably to a cooling temperature of less than or equal to about 25° C.

The conical mixing device with such temperature control may then be operated wherein the rotor of the mixing device may preferably be configured to mix in a multiple stage sequence, wherein each stage may be defined by a selected rotor rpm value (RPM) and time (T). Such multiple stage sequence may be particularly useful in the event that one may desire to provide some initial break-up of toner agglomerates. In addition, such initial first stage of mixing may be controlled in time, such that the conical mixer operates at such rpm values for a period of less than or equal to about 60 seconds, including all values and increments therein. Then, in a second stage of mixing, the rpm value may be set higher than the rpm value of the first stage, e.g., at an rpm value greater than about 500 rpm. Furthermore, the time for mixing in the second stage may be greater than about 60 seconds, and more preferably, about 60-180 seconds, including all values and increments therein. For example, the second stage may therefore include mixing at a value of about 1300-1350 rpm for a period of about 90 seconds. Following the above mentioned blending the toner with surface additives can be subjected to a screening step or a classifying step to remove any undesired large agglomerates or particles. It may be appreciated that following the screening or classifying step the toner can be placed in the conical mixer and further blended to achieve better adhesion of the surface additives to the toner surface.

It can therefore be appreciated that with respect to the mixing that may take place in the present invention, as applied to mixing EPA with toner, such mixing may efficiently take place in multiple stages in a conical mixing device, wherein EPA may be added in a first stage wherein the breaking of aggregates may be accomplished, followed by screening, and then additional EPA added before the toner is cooled. In addition, the temperature of the mixing process may again be controlled within such multiple staged mixing protocol such that the heating/cooling jacket and/or the polymer within the toner (as measured by an internal temperature probe) is maintained below its glass transition temperature (Tg).

It has been found that the mixing of toner particle with extra particulate additive in the conical mixing device according to the above provides a relatively more uniform surface distribution of the extra particulate additives.

The extra particulate additives may serve a variety of functions, such as to modify or moderate toner charge, increase toner abrasive properties, influence the ability/tendency of the toner to deposit on surfaces, improve toner cohesion, or eliminate moisture-induced tribo-excursions. The extra particulate additives may therefore be understood to be a solid particle of any particular shape. Such particles may be of micron or submicron size and may have a relatively high surface area. The extra particulate additives may be organic or inorganic in nature. For example, the additives may include a mixture of two inorganic materials of different particle size, such as a mixture of differently sized fumed silica or a mixture of different sized colloidal silica or a combination of both. The relatively small sized particles may provide a cohesive ability, e.g. ability to improve powder flow of the toner. The relatively larger sized particles may provide the ability to reduce relatively high shear contact events during the image forming process, such as undesirable toner deposition (filming).

U.S. Pat. No. 7,695,882 to Broce et al., assigned to the assignee of the present invention and its teachings are incorporated herein by reference, discusses the role of a conductive additive as an extra particulate additive in helping control the mass flow of a toner. The conductive titania additive was used in combination with an acicular titania, a small silica sized less than 20 nm and medium silica sized between 30 nm to 50 nm as EPAs that helped a toner to achieve the preferred toner mass on a developer roll and subsequently optimal print quality. However greater improvement in the reduction of toner starvation as well as improvement in toner usage was needed.

The examples herein are for the purposes of illustration and are not intended to be exhaustive or to limit the invention to the formulations discussed herein. The toner used in this study to decrease the onset of toner starvation and improve toner usage corresponds to a chemically prepared polyester toner with a Tg of about 61° C. (1^{st} scan onset) and comprising of a resin with Mn˜4K, Mp˜40K and Mw˜120K, 7% Nipex 35 black pigment, was treated with 0.5% Aerosil R812, 2% Aerosil RY-50, and 0.42% % FTL-110 titania, about 0.5% large silica such as SGSO100CDM8 (Sukgyung AT Inc.) and an additive as shown in the table. Evaluation of the toner was carried out in a Lexmark CS510 printer in a lab ambient (72° F./40% RH) and results are shown below.

TABLE 1
Performance of Additive in a Cold/Dry (60° F./8% RH) Environment

| | | | | L* | | |
|---|---|---|---|---|---|---|
| | | Q/M | DR M/A | across | Toner Usage/ | |
| Toner ID | Additive | (μC/g) | (mg/cm²) | page | TTC | Starve Onset |
| Comp. | None | −53.0 | 0.48 | 10.1- | 11.1 | 10K |
| Example 1 | | | | 12.0 | | |
| Example | 0.1% C805 | −33.6 | 0.44 | 9.8-12.7 | 19.1 | None |
| 1a | | | | | | |
| Example | 0.2% ET-300W | −50.8 | 0.48 | 9.8-12.1 | 11.2 | None |
| 1b | | | | | | |

As seen in Table 1, in the absence of a small size surface additive such as C805 alumina or an electro-conductive titania such as ET-300W, Example Toner 1 appears to exhibit high charge, the lift-off mass per unit area on a developer roll is about 0.48 mg/cm² and toner usage is about 11.1 mg/pg. However Example Toner 1 is prone to exhibiting starvation at about 10K pages. Starvation refers to a print quality defect wherein the printed page comprising of 100% solids appears light and exhibits several areas where no toner to very minimum toner present. This is also accompanied by significant non-uniformity in the print density and is considered objectionable. Starve phenomenon is related to the inability of a developer roll to achieve required toner mass on subsequent rotations during the printing process. It may also be related to a tendency towards a high adhesion of toner to DR and hence poor transfer to the imaging substrate and eventually the printed page. In contrast, the addition of an alumina such as C805 or an electro-conductive titania such as ET-300W in Example Toners 1a and 1b respectfully, results in a tendency towards a lower charge. The charge decrease is significant in Example Toner 1a and the undesirable resulting high toner usage is a result of an increase in the amount of wrong sign toner (toner with a very low charge that may not transfer to the page but is lost as waste toner). This is not a desirable result. In contrast, Example Toner 1b including an electro-conductive titania as an extra particulate additive shows a superior performance when compared to Example Toners 1 and 1a. Example Toner 1b shows a slight charge lowering, a surprising unexpected excellent toner usage (about 42% lower than Example Toners 1 and 1a), and importantly did not exhibiting a tendency towards starvation at 10K pages. Example Toner 1b was the only toner tested to simultaneously have excellent toner usage as well as no starvation onset.

The electro-conductive spherical titania can also play the role of a medium size additive. On similar grounds, the role of the large silica was also explored. It may be recalled that the large silica may be prepared via a fumed process or a sol-gel (or colloidal) process. As the inventors feel that a customer would benefit with minimum waste toner, and also achieve a higher toner usage efficiency, the role of large silica was explored. A black polyester chemical toner with a circularity of about 0.967, was surface treated with about 0.5% (wt.) Aerosil R812, 0.1% (wt.) ET-300W, 0.6% (wt.) FTL-110 and a medium silica and large silica as shown in Table 2. Toners were blended in a Cyclomix, using conditions stated previously and evaluated in a Lexmark CS510 printer (lab ambient condition). Results are shown below, RY50 (M1); TG-5185 (M2); SGSO100CDM8 (S1); VPSY110 (S2); VPRY4OS (S3).

TABLE 2
Toner usage performance as a function of medium, large silica type

| | | | | Q/M | M/A | Toner |
|---|---|---|---|---|---|---|
| | Medium | | Large | (□C/g) | (mg/cm²) | Usage |
| Toner ID | Silica | | Silica | (0K/20K) | (0K/20K) | (mg/pg) |
| Comparative | 2% | M1 | 0.5% S1 | −72/−41 | 0.50/0.53 | 12.6 |
| Example 2 | | | | | | |
| Example 2a | 2% | M1 | 0.5% S2 | −75/−41 | 0.44/0.53 | 12.0 |
| Example 2b | 2% | M1 | 0.5% S3 | −68/−42 | 0.49/0.53 | 10.0 |
| Example 2c | 2% | M2 | 0.5% S1 | −87/−48 | 0.42/0.54 | 10.6 |
| Example 2d | 2% | M2 | 0.5% S2 | −87/−54 | 0.42/0.54 | 10.5 |
| Example 2e | 2% | M2 | 0.5% S3 | −84/−55 | 0.44/0.50 | 9.9 |
| Example 2f | 1.5% | M1 | 0.5% S3 | −76/−49 | 0.48/0.50 | 8.9 |
| Example 2g | 0.75% | M1 | 0.5% S3 | −79/−53 | 0.42/0.50 | 10.6 |
| Example 2h | 1.5% | M2 | 0.5% S3 | −78/−54 | 046/0.52 | 12.5 |
| Example 2i | 0.75% | M2 | 0.5% S3 | −75/−54 | 0.45/0.52 | 13.7 |

Table 2 shows the performance of various toners in a Lexmark CS510 printer. Medium silica M1 is a 40 nm silica with a silicone oil surface treatment that is available from Evonik. In comparison, M2 is about 37 nm, and available from Cabot-Corp. Similarly, S1 is a large colloidal silica about 100 nm particle size with a silane surface treatment (SGSO100CDM8, Sukgyung AT Inc.), S2 is a colloidal silica sized 100 nm-110 nm with a silicone oil surface treatment (VPSY110, Evonik), and S3 is a 80 nm fumed silica with a silicone oil surface treatment (VPRY40S, Evonik). The toner charge and mass on DR show slight differences across the large silica used (S1, S2 and S3), the toner usage is significantly different, in particular between 51 and S3. It also appears that a large silica that is surface treated with a silicone oil is slightly better for toner usage than a large silica surface treated with a silane. A similar trend is observed when the medium silica is changed from M1 (RY50, Evonik) to M2 (TG-5185, Cabot-Corp.), where in the toner usage favors S3, however, all of the toners performed similarly. The similar performance may be a result of the higher toner charge that seems to be associated with the use of TG-5185 in comparison to RY50. An increase in toner usage is observed with every decrease in the amount of the medium silica (M1 or M2). It may be recalled here that the lowering of the amount of medium silica was not compensated with the addition of electro-conductive titania, as mentioned in Table 3. Hence, it is possible that the increase in amount of electro-conductive titania as part of the toner surface additive may lower toner usage for systems that have a lower amount of medium silica.

Further the effect of the levels of the spherical electro-conductive and acicular titanias were evaluated. Evaluation of the titania levels were carried out using a modified printer test. Whereas most tests include estimation of toner usage by calculating total toner used (printed and waste) by printing a set number of pages and weighing cartridge before and after test, the following test used an alternate protocol. In the following test, the test cartridges were run for a brief time, so as to remove any charge break-in (the charge change from the start of test to about 1000 pages, so as to achieve a charge saturation), and run in a developer unit, with no printed page. The toner in the cartridge or developer is churned, and since there is no printed text, the only development that can happen would correspond to a “charge” area development (CAD), rather than a “discharge” area development. In other words, the toner that gets used would correspond to a “wrong sign”. If the amount of toner thus used is high, it would indicate a tendency towards a higher toner usage. Based on the current assumptions, it will be appreciated that the current test results are similar to the results observed in Table 2.

TABLE 3
CAD as a function of spherical electroconductive titania,
acicular titania and medium silica levels

| | ET- | FTL- | | Q/M. | DR M/A | CAD |
|---|---|---|---|---|---|---|
| Toner ID | 300W | 110 | RY50 | (μC./g) | (mg/cm²) | (mg/rev) |
| Comp. | 0% | 0.6% | 2% | −48 | 0.36 | 0.40 |
| Example 3 | | | | | | |
| Example 3a | 0.1% | 0.6% | 2% | −56 | 0.32 | 0.35 |
| Example 3b | 0.1% | 0.42% | 2% | −52 | 0.46 | 1.10 |
| Example 3c | 0.5% | 0.42% | 1.5% | −52 | 0.32 | 0.70 |
| Example 3d | 1% | 0.42% | 1% | −46 | 0.32 | 0.50 |
| Example 3e | 0.05% | 0.42% | 2% | −49 | 0.47 | 1.20 |
| | C805 | | | | | |

In Table 3, the Comparative Example Toner 3, with no electro-conductive titania, exhibits a charge of about −48 μC/g and a corresponding toner usage of about 0.40 mg/rev of the photoconductor drum. Example Toner 3a on the other hand shows a slight improvement in toner usage (or lower waste toner) in comparison to the Comparative Example Toner 3. It will be appreciated that in comparing Example Toners 3a and 3b, wherein the electro-conductive titania is maintained at a constant level, with the only change corresponding to the amount of acicular titania i.e. FTL-110, the waste toner or toner usage is increased significantly. The electro-conductive titania is about 40 nm and can function like a medium size silica, hence the ET-300W and RY-50 (40 nm, 40 m²/g) ratio was maintained at about 2%, and modified accordingly. Also, example 3c, wherein the spherical electroconductive titania was increased to 0.5% (wt.) the corresponding toner shows a decrease in amount of CAD toner. In contrast, Example 3e that incorporates about 0.05% (wt.) of an alumina, shows a significantly high CAD. This result may imply that despite having an electro-conductive additive, there is no tendency towards an increase in amount of wrong sign toner, and hence the toner usage is relatively constant. It may be concluded, that the electro-conductive titania can be used at a higher level as a medium sized spacer, without impacting the toner usage. It may also be appreciated that spherical electroconductive titania can serve a dual purpose, by acting as a spacer (replacing a medium silica) and also help lower waste toner in the system.

It may be concluded that the select use of surface additives such as an electro-conductive titania in combination with an acicular titania, and various size silica surface additives can be used in a manner to achieve a higher toner usage efficiency, i.e. lower toner waste. While the additives mentioned here are not exhaustive, for one skilled in the art, it may be appreciated that the concept may be extended to similar types of titania or silica, or mixtures thereof.

1. A toner composition, comprising:
toner particles;
extra particular additives including:
(1) medium sized silica particles having a primary particle size in the range of 30 nm to 60 nm and present in the range of 0.1% to 2.0% wt. of the toner composition,
(2) large sized silica particles having a primary particle size in the range of 60 nm to about 110 nm and present in the range of 0.1% to 2% by weight of the toner composition,
(3) acicular titania oxide having a mean particle length in the range of 0.1 μm to 3.0 μm and a mean particle diameter in the range of 0.01 μm to 0.2 μm; and
(4) antimony oxide doped tin oxide (Sb₂O₅ doped SnO₂) coated titania electro-conductive additive having a particle size in the range of 10 nm to 400 nm.

2. The toner composition of claim 1, further comprising small sized silica particles having a primary particle size in the range of 2 nm to 20 nm.

3. The toner composition of claim 1, wherein the medium sized silica particles are treated with a surface treatment selected from the group consisting of hexamethyldisilazane and polydimethylsiloxane.

4. The toner composition of claim 1, wherein the large sized silica particles are treated with a surface treatment selected from the group consisting of hexamethyldisilazane, polydimethylsiloxane, dimethyldichlorosilane, dimethyldiethoxysilane octyltrialkoxysilane and combinations thereof.

5. The toner composition of claim 1, wherein the acicular titania oxide and antimony oxide doped tin oxide (Sb₂O₅ doped SnO₂) coated titania electro-conductive additive is present in the range of about 0.01% to 2.0% by wt. of the toner composition.

6. The toner composition of claim 1, wherein the antimony oxide doped tin oxide (Sb₂O₅ doped SnO₂) coated titania electro-conductive additive has a primary particle size of 40 nm.

7. The toner composition of claim 1, wherein the acicular titania oxide has a particle length of 1.68 μm and a particle diameter of 130 nm.

8. The toner composition of claim 1, wherein the ratio of the medium sized silica particles and the large sized silica particles to the acicular titania oxide and the antimony oxide doped tin oxide (Sb₂O₅ doped SnO₂) coated titania electro-conductive additive is about 3.5 to about 1.

9. The toner composition of claim 1, wherein the ratio of the antimony oxide doped tin oxide (Sb₂O₅ doped SnO₂) coated titania electro-conductive additive to the acicular titania oxide is about 1 to about 0.15.

10. The toner composition of claim 1, wherein the toner particles include a polyester based resin.

11. The toner composition of claim 1, wherein the large sized silica particles are fumed.

12. The toner composition of claim 1, wherein the large sized silica particles are colloidal.

13. A toner composition, comprising:
toner particles,
extra particular additives including:
(1) medium sized silica particles having a primary particle size in the range of 30 nm to 60 nm and present in the range of 0.1% to 2.0% wt. of the toner composition,
(2) large sized silica particles having a primary particle size in the range of 60 nm to about 110 nm and present in the range of 0.1% to 2% by weight of the toner composition,
(3) acicular titania oxide having a mean particle length in the range of 0.1 μm to 3.0 μm and a mean particle diameter in the range of 0.01 μm to 0.2 μm,
(4) antimony oxide doped tin oxide (Sb₂O₅ doped SnO₂) coated titania electro-conductive additive having a particle size in the range of 10 nm to 400 nm; and
(5) small sized silica particles having a primary particle size in the range of 5 nm to 15 nm and present in the range of 0.1% to 0.5% by weight of the toner composition.

14. The toner composition of claim 13, wherein the ratio of the medium sized silica particles and the large sized silica particles to the acicular titania oxide and the antimony oxide doped tin oxide (Sb₂O₅ doped SnO₂) coated titania electro-conductive additive is about 3.5 to about 1.

15. The toner composition of claim 13, wherein the ratio of the antimony oxide doped tin oxide (Sb₂O₅ doped SnO₂) coated titania electro-conductive additive to the acicular titania oxide is about 1 to about 0.15.

16. The toner composition of claim 13, wherein the large sized silica particles are fumed.

17. The toner composition of claim 13, wherein the large sized silica particles are colloidal.

18. The toner composition of claim 13, wherein the toner particles include a polyester based resin.

19. The toner composition of claim 13, wherein the antimony oxide doped tin oxide (Sb₂O₅ doped SnO₂) coated titania electro-conductive additive has a primary particle size of 40 nm.

20. The toner composition of claim 13, wherein the acicular titania oxide has a particle length of 1.68 μm and a particle diameter of 130 nm.
